(19) United States
(12) Patent Application Publication
(10) Pub. No.: US 2010/0110065 A1
(43) Pub. Date: May 6, 2010

(54) DRIVING CIRCUIT AND DRIVING METHOD FOR ORGANIC EL PANEL

(75) Inventor: Shinichi ABE, Kyoto (JP)

Correspondence Address: CANTOR COLBURN, LLP, 20 Church Street, 22nd Floor, Hartford, CT, 06103, US

(73) Assignee: ROHM CO., LTD., Kyoto (JP)

(21) Appl. No.: 12/612,506

(22) Filed: Nov. 4, 2009

(30) Foreign Application Priority Data
Nov. 5, 2008 (JP) 2008-284004

(51) Int. Cl. G06F 3/038

(52) U.S. Cl. 345/213; 345/76

(57) ABSTRACT

A data driver includes multiple driving units which are provided in increments of data lines of a display panel, and each of which supplies a driving signal to a corresponding data line. A scanning driver drives multiple scanning lines of the display panel. Image memory stores image data which is supplied from an external circuit, and which is to be displayed on the panel. A line code generating unit encodes line data in increments of the scanning lines by predetermined computation processing, thereby generating a line code for each scanning line. A controller controls the data driver and the scanning driver based upon the image data stored in the image memory and the line codes generated in increments of the scanning lines.

### BACKGROUND OF THE INVENTION

1. Field of the Invention

The present invention relates to a driving technique for an organic EL panel.

2. Description of the Related Art

Organic EL (electroluminescence) displays and driving circuits thereof are being actively developed as next-generation thin displays to serve as a substitution for liquid crystal panels. A passive matrix organic EL panel includes multiple scanning lines, multiple data lines, and multiple pixels. Organic EL elements provided in increments of pixels are each arranged at intersections of the scanning lines and the data lines in the form of a matrix. Each of the organic EL elements is arranged with the anode thereof connected to the data line and with the cathode thereof connected to the scanning line.

In order to drive such a passive matrix organic EL panel, an anode driver (data driver) which drives the data lines and a cathode driver (scanning line driver) which drives the scanning lines are employed. The scanning driver sequentially selects the scanning lines to be controlled so as to perform light emission operation for the organic EL elements arranged in the form of a matrix. The data driver drives each of the data lines synchronously with the selection operation of the scanning driver.

With such a passive matrix organic EL panel, the organic EL elements arranged at each row can emit light during only the period of time where the corresponding scanning line is selected. Accordingly, increase in the resolution in the vertical direction of the panel (the number of scanning lines) results in the selection time period for each scanning line being reduced, leading to a problem of reduced light emission luminance. In a case in which electric current supplied to the data driver is increased in order to cancel out the reduction in the light emission luminance, such an arrangement leads to a problem of increased power consumption. Furthermore, there is a need to charge and discharge capacitance at each organic EL element every time the corresponding scanning line is selected. For this reason, such an increased number of scanning lines also leads to an increase in power consumption.
[Patent Document 1]

US Patent Application Publication 2007/46603 A1 Specification
[Patent Document 2]

U.S. Patent Application Publication 2007/46611 A1 Specification

### SUMMARY OF THE INVENTION

The present invention has been made in view of such a situation. Accordingly, it is a general purpose of the present invention to provide a driving circuit having the advantage of reduced power consumption.

An embodiment of the present invention relates to a driving circuit for an organic EL (electroluminescence) display panel having multiple pixels arranged in the form of a matrix. The driving circuit comprises: a data driver including multiple driving units which are each provided for multiple data lines of the display panel, and each of which supplies a driving signal to the corresponding data line; a scanning driver which drives multiple scanning lines of the display panel; memory which stores image data which is to be displayed on the panel and which is supplied from an external circuit; a line code generating unit which encodes the image data in increments of the scanning lines by predetermined computation processing, thereby generating a code for each scanning line; and a controller which controls the data driver and the scanning driver based upon the image data stored in the memory and the codes generated in increments of the scanning lines. The scanning driver selects, at the same time, K (K is an integer which is equal to or greater than 2) scanning lines from among the multiple scanning lines in a case in which the K scanning lines are associated with the same code.

With such an embodiment, the image data is compressed by encoding the image data in increments of scanning lines. Thus, such an embodiment allows the capacity of the memory or register for storing the codes to be reduced. Furthermore, such an embodiment provides simple processing as compared with processing involving a comparison between uncompressed data. Furthermore, such an embodiment selects particular multiple scanning lines at the same time, thereby reducing the number of the switching operations for the scanning lines. Thus, such an embodiment reduces waste of electric power to perform pre-charging processing involved in the switching operation. In a different perspective, with such an arrangement in which such particular multiple scanning lines are selected at the same time, these scanning lines can be driven for an increased driving time period, thereby raising the luminance of the pixels on these scanning lines.

Also, the scanning driver may select, at the same time for a time period K times as long as a normal selection time period, the K (K is an integer which is equal to or greater than 2) scanning lines associated with the same code. Also, the data driver may set the values of the corresponding driving signals to be generated by the multiple driving units to a value 1/K times as much as that in a normal operating state.

With such an arrangement, the particular pixels associated with the same pixel value emit light with a luminance level 1/K times as high as the normal luminance level for a time period K times as long as the normal light-emission period. Thus, such an arrangement provides reduced power consumption while maintaining the brightness level perceived by the human eye.

Also, the line code generating unit may perform encoding processing using a minimum perfect hash function. By using the a minimum perfect hash function, such an arrangement is capable of associating the data, which has not been encoded, with the data which has been encoded, in a one-to-one manner.

Also, the line code generating unit may perform encoding processing every time image data is received in increments of scanning lines.

Also, a driving circuit according to one embodiment may further comprise memory which stores codes in increments of the scanning lines.

Another embodiment of the present invention relates to a display apparatus. The display apparatus comprises: an organic EL (electroluminescence) display panel having multiple pixels arranged in the form of a matrix; and any one of the driving circuits described above, which drives the display panel.

Yet another embodiment of the present invention relates to a driving method for an organic EL (electroluminescence) display panel having multiple pixels arranged in the form of a matrix. The driving method comprises: supplying a driving signal to each of multiple data lines of the display panel; driving multiple scanning lines of the display panel; encoding image data to be displayed on the panel in increments of the scanning lines by predetermined computation processing, thereby generating a code for each scanning line. In the operation for driving the scanning lines, K (K is an integer which is equal to or greater than 2) scanning lines are selected at the same time from among the multiple scanning lines in a case in which the K scanning lines are associated with the same code.

It is to be noted that any arbitrary combination or rearrangement of the above-described structural components and so forth is effective as and encompassed by the present embodiments.

Moreover, this summary of the invention does not necessarily describe all necessary features so that the invention may also be a sub-combination of these described features.

### BRIEF DESCRIPTION OF THE DRAWINGS

Embodiments will now be described, by way of example only, with reference to the accompanying drawings which are meant to be exemplary, not limiting, and wherein like elements are numbered alike in several Figures, in which:

FIG. 1 is a block diagram which shows a configuration of a display apparatus according to an embodiment;

FIG. 2 is a diagram which shows an example of image data displayed on a panel; and

FIG. 3 is a time chart which shows a driving sequence for a driving circuit for displaying the image data shown in FIG. 2.

### DETAILED DESCRIPTION OF THE INVENTION

The invention will now be described based on preferred embodiments which do not intend to limit the scope of the present invention but exemplify the invention. All of the features and the combinations thereof described in the embodiment are not necessarily essential to the invention.

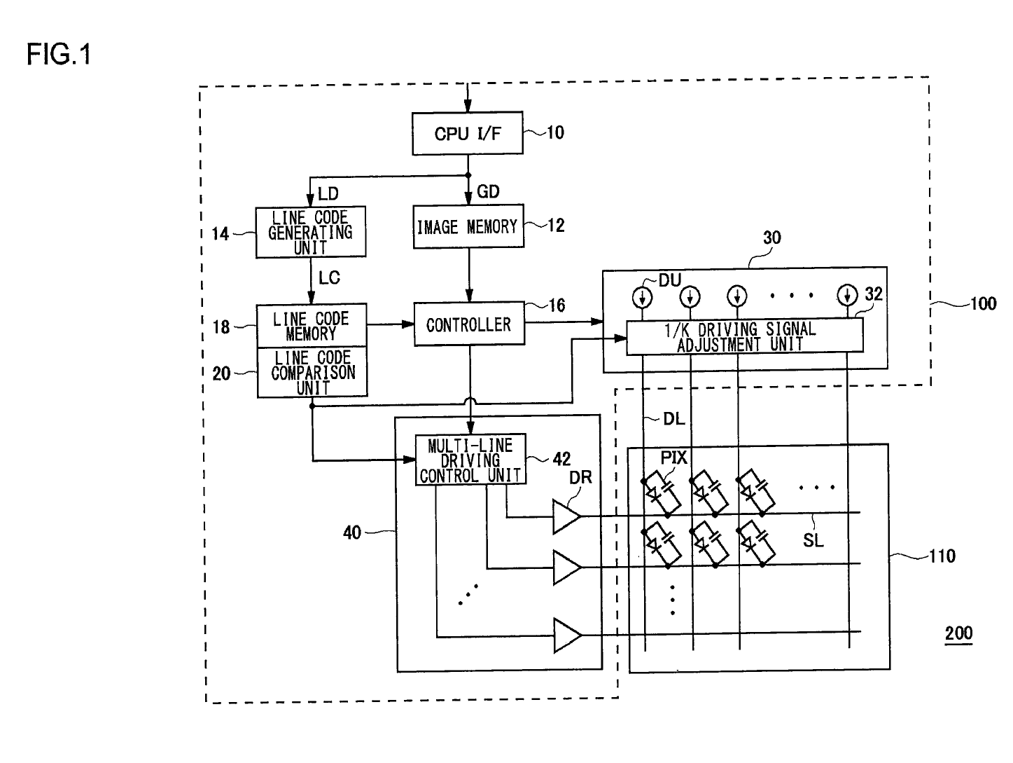

FIG. 1 is a block diagram which shows a configuration of a display apparatus 200 according to an embodiment. The display apparatus 200 includes an organic EL display panel (which will simply be referred as “panel” hereafter) 110 and a driving circuit 100 thereof.

The panel 110 includes: multiple pixels PIX arranged in the form of a matrix; multiple scanning lines SL (cathode lines) provided in increments of rows of the matrix; and multiple data lines DL (anode lines) provided in increments of columns thereof. Each pixel PIX is represented by an equivalent circuit including: an organic EL element (OLED) with the cathode thereof connected to the corresponding scanning line SL and with the anode thereof connected to the corresponding data line DL; and a capacity provided in parallel with the OLED.

The driving circuit 100 includes a CPU interface 10, image memory 12, a line code generating unit 14, a controller 16, line code memory 18, a line code comparison unit 20, a data driver 30, and a scanning driver 40. These components may be monolithically integrated on a single semiconductor substrate. Also, an arrangement may be made in which these components are arranged on several separate substrates.

The data driver 30 includes multiple driving units DU and a driving signal adjustment unit 32. The multiple driving units DU are each provided for multiple data lines DL. Each driving unit DU supplies a driving signal S1 to the corresponding data line DL. Each driving unit DU is n-bit (2ⁿ-gradation) D/A converter using the PWM (pulse width modulation) or PAM (pulse amplitude modulation). The driving signal S1 is an electric current signal that corresponds to the luminance, for example. In a different perspective, the driving signal S1 is a voltage signal for charging the capacitance of the pixel PIX.

The scanning driver 40 sequentially selects the multiple scanning lines SL in a cyclic manner. Specifically, the scanning driver 40 fixes, to the ground potential (GND or VSS), the electric potential at the scanning line SL to be selected so as to perform the light emission operation.

The CPU interface 10 receives image data output from an external host processor, in increments of pixel groups each composed of a predetermined number of pixels. The CPU interface 10 stores the image data thus received in the image memory 12, and outputs the image data to the line code generating unit 14 in increments of scanning lines (for each line).

The line code generating unit 14 encodes the image data (line data LD), which has been received for each scanning line, by predetermined computation processing, thereby generating codes (line codes LC) in increments of scanning lines. The line code generating unit 14 executes the encoding operation every time it receives the line data LD so as to convert the line data LD into the line code LC. In other words, the line code generating unit 14 does not refer to the image data stored in the image memory 12. Instead, the line code generating unit 14 performs the encode processing on the line data LD directly input from the CPU interface 10. That is to say, the writing of the image data GD to the image memory 12 and the writing of the line code LC to the line code memory 18 are executed at the same time in a parallel manner, thereby allowing the processing to be performed without concern of execution overhead.

The line data LD corresponds to the line code LC in a one-to-one manner. That is to say, a state in which the codes LC are identical to each other means that the corresponding line data LD are identical to each other. For example, the predetermined computation processing may be processing using a minimum perfect hash function. Such an arrangement using the minimum perfect hash function associates the line data LD, which has not been encoded, with the line code LC which has been encoded in a one-to-one manner, thereby providing data compression.

The line code memory 18 stores the line codes LC sequentially output from the line code generating unit 14. The data amount of the line codes LC is smaller than that of the line data LD. Accordingly, the capacity of the line code memory 18 is smaller than that of the image memory 12. As a result, the line code memory 18 affect the circuit area but little.

The line code comparison unit 20 compares the line codes LC stored in the line code memory 18 in increments of lines, and extracts the scanning lines associated with the same code.

The controller 16 controls the data driver 30 and the scanning driver 40 based upon the image data GD stored in the image memory 12 and the line codes LC generated in increments of the scanning lines SL.

The scanning driver 40 selects, at the same time, K (K is an integer of 2 or more) scanning lines associated with the same line code LC. The processing is executed by the multi-line driving control unit 42. Specifically, the multi-line driving control unit 42 selects, at the same time, the scanning lines associated with the same code, with reference to the comparison results for the line codes LC obtained by the line code comparison unit 20.

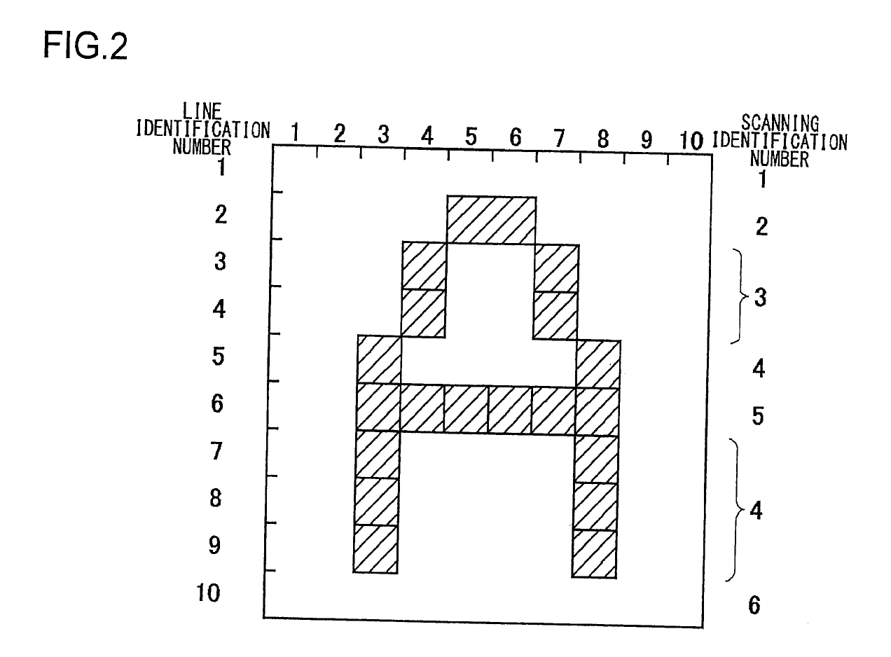

FIG. 2 is a diagram which shows an example of the image data GD displayed on the panel 110. FIG. 2 shows the pixels in the form of a 10×10 matrix in a case in which the luminance of each pixel is controlled in a binary manner between the ON state (1) and the OFF state (0). In the example shown in FIG. 2, the line data at the third row and the line data at the fourth row are the same. Furthermore, the line data at the fifth row and those at the seventh through ninth rows are the same.

The scanning identification numbers shown in FIG. 2 indicate that the multiple scanning lines associated with the same line code (line data) are selected at the same time. The same scanning identification number is assigned to the scanning lines associated with the same line data.

That is to say, the scanning driver 40 sequentially and separately selects the scanning lines SL₁ and SL₂ at the first row and the second row (scanning identification numbers 1 and 2), synchronously with a horizontal synchronization signal. Next, the scanning driver 40 selects the scanning lines SL₃ and SL₄ at the third and fourth rows at the same time (scanning identification number 3). Subsequently, the scanning driver 40 selects, at the same time, the scanning line SL₅ at the fifth row and the scanning lines SL₇ through SL₉ at the seventh row through the ninth row (Scan identification number 4). Subsequently, the scanning driver 40 selects the scanning line SL₆ at the sixth row (scanning identification number 5). Lastly, the scanning driver 40 selects the scanning line SL₁₀ at the tenth row (scanning identification number 6).

During the operation for the scanning identification number 3, the driving unit DU₄ at the fourth column and the driving unit DU_{B} at the seventh column supply the driving signals to the corresponding data lines DL₄ and DL₇. During this period of time, the scanning line SL₃ at the third row and the scanning line SL₄ at the fourth row are selected, which instructs the pixels at the fourth column and the seventh column of these scanning lines SL to emit light.

For example, in a case in which the image data shown in FIG. 2 is displayed, conventional scanning methods require ten switching operations for ten scanning lines SL per frame. On the other hand, an arrangement employing the driving circuit 100 according to the embodiment requires only six switching operations. In the operation for driving the panel 110, each pixel PIX must be initialized by charging and discharging the capacitance provided to the pixel PIX before the timing at which the driving signal that corresponds to the luminance is supplied to the pixel PIX every time the scanning line SL is switched. Accordingly, electric power is wasted every time each scanning line SL is switched. With the driving circuit 100 according to the embodiment, the number of times the scanning lines are switched can be reduced, thereby providing reduced power consumption. Furthermore, such reduced power consumption yields another advantage, which is reduction in heat generation.

The performance for reducing power consumption changes according to the image data GD to be displayed. For example, in a case in which the image data at a certain frame is the data for displaying white data over the entire area, all the line codes are the same. In this case, all the scanning lines SL are selected at the same time by the multi-line driving control unit 42. That is to say, the selection operation for the scanning lines is executed only once for this single frame. Accordingly, in this case, the performance for reducing the power consumption is the maximum. Also, in some cases, an auxiliary display is provided to an electronic device in order to display the current time or in order to display only a still image. In many cases, such an auxiliary display displays a monotonous image. Accordingly, with such an auxiliary display, the same line data is displayed at multiple scanning lines with a high probability. Thus, the driving circuit 100 according to the embodiment can be suitably applied to such an auxiliary display.

When the same line code is to be displayed at multiple scanning lines, the scanning driver 40 may select these scanning lines even if the scanning lines are not adjacent to one another. Such an arrangement provides the maximum performance for reducing the power consumption. It should be noted that, in this operation, the scanning driver 40 scans the scanning lines SL after the line codes LC have been generated for all the scanning lines SL.

Also, the scanning driver 40 may select, at the same time, only the scanning lines which are positioned adjacent to one another and which are associated with the same line code. With such an arrangement, the panel 110 can be driven before the completion of the generation of the line codes LC for all the scanning lines SL. In a case in which the image shown in FIG. 2 is displayed, a set of the scanning lines at the seventh through ninth rows are not adjacent to the scanning line at the fifth row. Accordingly, different scanning identification numbers are assigned to the set of the scanning lines at the seventh through ninth rows and the scanning line at the fifth row.

It should be noted that the image data is not restricted to binary data having just the white and black values; rather, the image data may be n-bit gray-scale or color image data.

Furthermore, the driving circuit 100 executes the following processing.

In a case in which K (K is an integer of 2 or more) scanning lines SL are associated with the same line code LC, the scanning driver 40 selects these scanning lines SL at the same time for a period of time K times as long as a normal selection time period defined by the horizontal synchronization signal. The driving signal adjustment unit of the data driver 30 sets the values of the driving signals to be generated by the multiple driving units DU to a value 1/K times as much as that in the normal driving state.

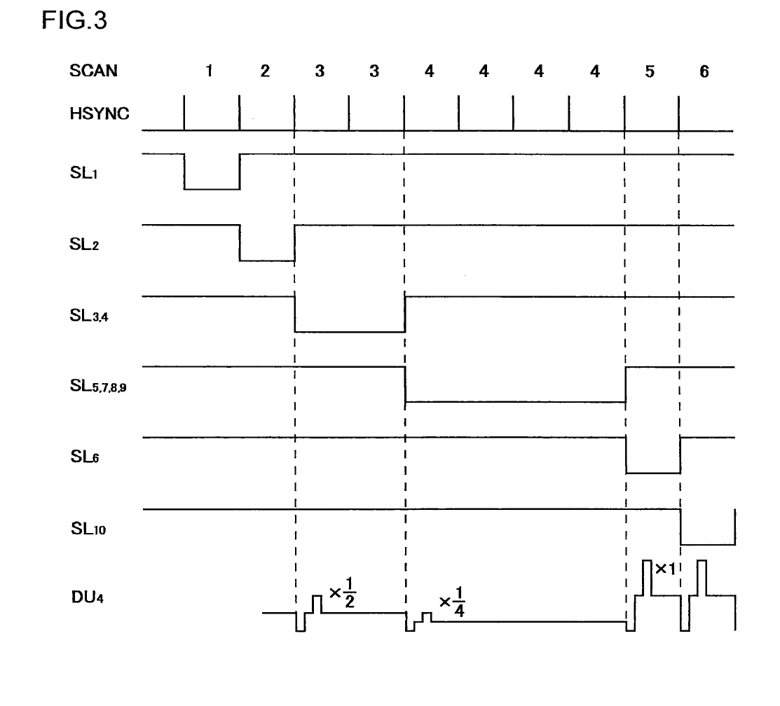

Next, description will be made regarding the operation of the driving circuit 100. FIG. 3 is a time chart which shows the driving sequence for the driving circuit 100 when the image data GD shown in FIG. 2 is displayed. The time chart shown in FIG. 3 shows the horizontal synchronization signal HSYNC, electric potentials at the multiple scanning lines SL, and the driving signal output from the driving unit DU₄.

By performing such processing, such an arrangement is capable of instructing the pixels on the scanning lines SL to be driven at the same time to emit light with a luminance level 1/K times as high as the normal luminance level for a time period K times as long as the normal light-emission period. Thus, such an arrangement provides reduced power consumption while maintaining the brightness level perceived by the human eye.

While the preferred embodiments of the present invention have been described using specific terms, such description is for illustrative purposes only, and it is to be understood that changes and variations may be made without departing from the spirit or scope of the appended claims.

What is claimed is:

1. A driving circuit for an organic EL (electroluminescence) display panel having a plurality of pixels arranged in the form of a matrix, the driving circuit comprising:
a data driver including a plurality of driving units which are each provided for a plurality of data lines of the display panel, and each of which supplies a driving signal to the corresponding data line;
a scanning driver which drives a plurality of scanning lines of the display panel;
memory which stores image data which is to be displayed on the panel and which is supplied from an external circuit;
a line code generating unit which encodes the image data in increments of the scanning lines by predetermined computation processing, thereby generating a code for each scanning line; and
a controller which controls the data driver and the scanning driver based upon the image data stored in the memory and the codes generated in increments of the scanning lines,
wherein the scanning driver selects, at the same time, K (K is an integer which is equal to or greater than 2) scanning lines from among the plurality of scanning lines in a case in which the K scanning lines are associated with the same code.

2. A driving circuit according to claim 1, wherein the scanning driver selects, at the same time for a time period K times as long as a normal selection time period, the K (K is an integer which is equal to or greater than 2) scanning lines associated with the same code,
and wherein the data driver sets the values of the corresponding driving signals to be generated by the plurality of driving units to a value 1/K times as much as that in a normal operating state.

3. A driving circuit according to claim 1, wherein the line code generating unit performs encoding processing using a minimum perfect hash function.

4. A driving circuit according to claim 1, wherein the line code generating unit performs encoding processing every time image data is received in increments of scanning lines.

5. A driving circuit according to claim 1, further comprising memory which stores codes in increments of the scanning lines.

6. A display apparatus comprising:
an organic EL (electroluminescence) display panel having a plurality of pixels arranged in the form of a matrix; and
a driving circuit according to claim 1, which drives the display panel.

7. A driving method for an organic EL (electroluminescence) display panel having a plurality of pixels arranged in the form of a matrix, the driving method comprising:
supplying a driving signal to each of a plurality of data lines of the display panel;
driving a plurality of scanning lines of the display panel;
encoding image data to be displayed on the panel in increments of the scanning lines by predetermined computation processing, thereby generating a code for each scanning line; and
wherein, in the operation for driving the scanning lines, K (K is an integer which is equal to or greater than 2) scanning lines are selected at the same time from among the plurality of scanning lines in a case in which the scanning lines are associated with the same code.
